(19) United States
(12) Patent Application Publication
(10) Pub. No.: US 2012/0306761 A1
(43) Pub. Date: Dec. 6, 2012

(54) ELECTRONIC DISPLAY DEVICE

(75) Inventor: Tzu-Hung Cheng, Taipei (TW)

(73) Assignee: PRIMAX ELECTRONICS LTD., Taipei (TW)

(21) Appl. No.: 13/207,707

(22) Filed: Aug. 11, 2011

(30) Foreign Application Priority Data
Jun. 3, 2011 (TW) 100119527

(51) Int. Cl. G06F 3/02; G09G 5/00

(52) U.S. Cl. 345/169; 345/2.3

(57) ABSTRACT

An electronic display device is in communication with a social website in a network communication manner for receiving an image file from the social website. The image file is shown on the electronic display device, and transmitted to a handheld electronic device in a wireless transmission manner. Via an input module of the handheld electronic device, the user of the handheld electronic device may generate an evaluation message. The evaluation message may be transmitted to the electronic display device in a wireless transmission manner. A transfer program installed in the electronic display device is executed to transmit said evaluation message to the social website in the network communication manner.

### FIELD OF THE INVENTION

The present invention relates to an electronic display device, and more particularly to an electronic display device for playing image files.

### BACKGROUND OF THE INVENTION

With increasing development of science and technology, an electronic display device has become a very popular consumer electronic device. The main function of the electronic display device is to output image files. Generally, the image files comprise static electronic files (e.g. photos) and dynamic electronic files (e.g. movies). The electronic display device is for example a TV set, a computer screen, a digital photo frame and a digital signage.

Hereinafter, the configurations of a conventional electronic display device will be illustrated with reference to FIGS. 1 and 2. FIG. 1 is a schematic perspective view illustrating the outward appearance of a conventional electronic display device. FIG. 2 is a schematic perspective view illustrating the outward appearance of the conventional electronic display device of FIG. 1 and taken along another viewpoint. For example, the conventional electronic display device 1 shown in FIGS. 1 and 2 is a digital photo frame. The conventional electronic display device 1 comprises a display screen 10, a storage medium 11 and a connecting slot 12. The storage medium 11 is disposed within the electronic display device 1 for storing at least one image file P1. The display screen 10 is disposed on a surface 13 of the electronic display device 1. The display screen 10 is in communication with the storage medium 11 for showing the stored image file P1. The connecting slot 12 is located at a sidewall 14 of the electronic display device 1. When a memory card 15 is inserted into the connecting slot 12, the memory card 15 can be accommodated within the connecting slot 12. The memory card 15 is used for storing the image file P1. Since the memory capacity of the storage medium 11 is limited, the connecting slot 12 is usually a necessary component of the electronic display device 1 for accommodating the memory card 15. By means of the above configurations, the electronic display device 1 is capable of showing the image file P1.

Recently, as the science and technology are increasingly developed, more and more computer users utilize social websites to communicate with each other. The computer users join the social websites one after another to upload the image file P1 to the social websites. Consequently, other computer users can watch and evaluate the image file P1. In a case that the image file P1 is positively evaluated by so many other computer users, it means that the image file P1 win recognition by the public. Moreover, the image file P1 may be shown through the memory card and the electronic display device 1. However, this way of showing the image file P1 is very troublesome. For solving the above drawbacks, a network-enabled electronic display device is disclosed.

FIG. 3 schematically illustrates a conventional network-enabled electronic display device in communication with a social website. The network-enabled electronic display device 2 comprises a display screen 20, a storage medium 21 and a network module 23. The relationships between the display screen 20, the storage medium 21 and the connecting slot are similar to those of the conventional electronic display device 1 as shown in FIGS. 1 and 2, and are not redundantly described herein. The network module 23 is disposed within the electronic display device 2 and connected with the storage medium 21. When the network module 23 is in communication with a social website F, the image file P1 from the social website F may be received by the network module 23. The image file P1 is copied and then transmitted to the storage medium 21 through the network module 23. In such way, the network-enabled electronic display device 2 is capable of playing the image file P1 via the display screen 20.

The network-enabled electronic display device 2 is able to connect with the social website F and play the image file P1 that is stored in the social website F. Consequently, the image file P1 shown on the conventional electronic display device 2 can be watched by the observers passing through the electronic display device 2. However, the electronic display device 2 still has some drawbacks. For example, since the network-enabled electronic display device 2 only has the function of playing the image files, the observers passing through the electronic display device 2 fail to give evaluation messages about the image file P1. Moreover, if the network-enabled electronic display device 2 is used as a digital signage for offering advertisement, the observers passing through the electronic display device 2 fail to give remarks about the image file P1. Therefore, there is a need of providing an electronic display device capable of receiving the evaluation message.

### SUMMARY OF THE INVENTION

The present invention relates to an electronic display device capable of receiving the evaluation message.

In accordance with an aspect of the present invention, there is provided an electronic display device. The electronic display device is in communication with a social website. The image file is stored in the social website. The electronic display device includes a display screen, a wireless signal transmitter, a wireless signal receiver and a transfer program. The display screen is disposed on a surface of the electronic display device for showing the image file. The wireless signal transmitter is disposed within the electronic display device for issuing a wireless connection signal to a handheld electronic device in the vicinity of the electronic display device, thereby establishing connection between the electronic display device and the handheld electronic device. The image file is transmitted from the wireless signal transmitter to the handheld electronic is device in a wireless transmission manner. The wireless signal receiver disposed within the electronic display device for receiving an evaluation message from the handheld electronic device. The transfer program is installed in the electronic display device, and executed to transmit the evaluation message to the social website.

In an embodiment, the electronic display device further includes a storage device for storing the image file from the social website, wherein the storage device is disposed within the electronic display device or externally connected with the electronic display device.

In an embodiment, the storage device is a storage medium disposed within the electronic display device. Alternatively, the storage device is a memory card or a removable storage device inserted in a connecting slot of the electronic display device.

In an embodiment, the electronic display device further includes a network module, which is disposed within the electronic display device and connected with the storage device. The network module is in communication with the social website through Internet connection or in a wireless network communication manner, so that the image file from the social website is copied and transmitted to the storage device.

In an embodiment, the wireless network communication manner is a 3G wireless network communication manner, a 4G wireless network communication manner, a wireless fidelity (Wi-Fi) communication manner, a general packet radio service (GPRS) communication manner or an Edge network communication manner.

In an embodiment, the wireless signal transmitter is a Bluetooth signal transmitter or a near field communication (NFC) signal transmitter, and the wireless signal receiver is a Bluetooth signal receiver or a near field communication (NFC) signal receiver.

In an embodiment, the handheld electronic device includes a second storage device, a second display screen, an input module and a second wireless signal transmitter. The second storage device is disposed within the handheld electronic device for storing the image file from the electronic display device. The second display screen is disposed on a surface of the handheld electronic device for showing the image file from the electronic display device. The input module is disposed on the surface of the handheld electronic device for inputting characters or symbols as the evaluation message. The second wireless signal receiver is disposed within the handheld electronic device for receiving the wireless connection signal from the electronic display device. The second wireless signal transmitter is disposed within the handheld electronic device for transmitting the evaluation message to the wireless signal receiver of the electronic display device.

In an embodiment, the input module is a physical keyboard arranged beside the second display screen and disposed on the surface of the handheld electronic device, or the input module is an on-screen keyboard shown on the second display screen.

In an embodiment, when the wireless connection signal from the wireless signal transmitter is received by the handheld electronic device, a connection confirming interface is shown on the second display screen. Via the connection confirming interface, the connection between the electronic display device and the handheld electronic device is determined to be established or not established.

In an embodiment, the connection confirming interface includes a yes option and a no option. When the yes option is clicked, the connection between the electronic display device and the handheld electronic device is agreed to be established. Whereas, when the no option is clicked, the connection between the electronic display device and the handheld electronic device is refused to be established.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional electronic display device;

FIG. 2 is a schematic perspective view illustrating the outward appearance of the conventional electronic display device of FIG. 1 and taken along another viewpoint;

FIG. 3 schematically illustrates a conventional internet-enabled electronic display device in communication with a social website;

FIG. 4 schematically illustrates an electronic display device in communication with a social website according to an embodiment of the present invention;

FIG. 5 schematically illustrates the connection between the electronic display device of the present invention and a handheld electronic device;

FIG. 6 schematically illustrates the handheld electronic device in communication with the electronic display device according to an embodiment of the present invention; and

FIG. 7 schematically illustrates the contents of a connection confirming interface of the handheld electronic device in communication with the electronic display device according to an embodiment of the present invention.

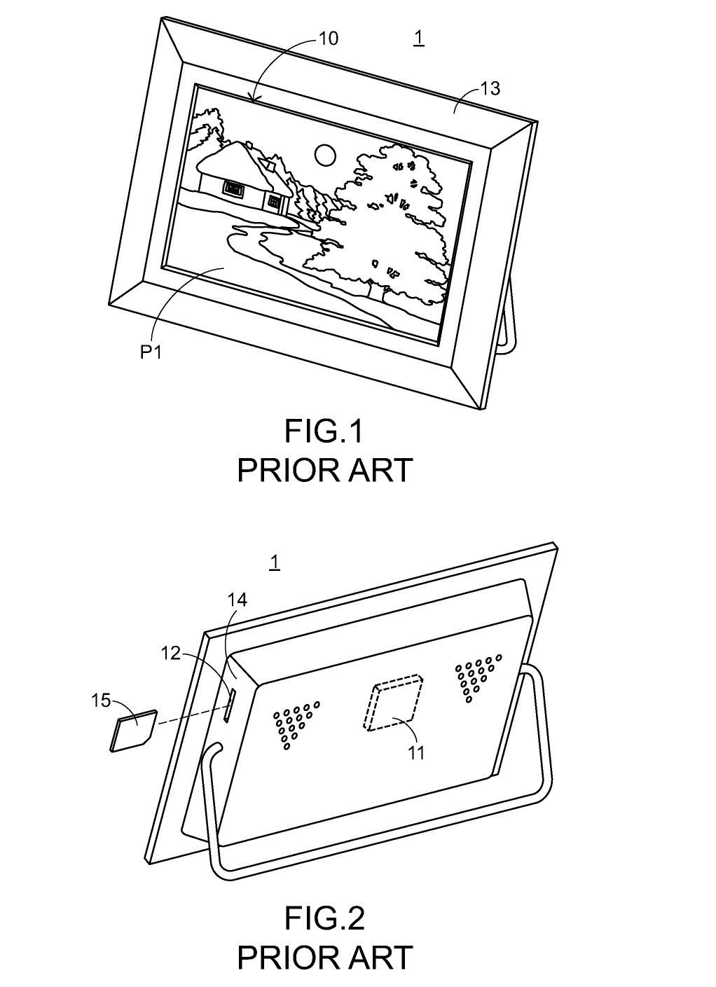

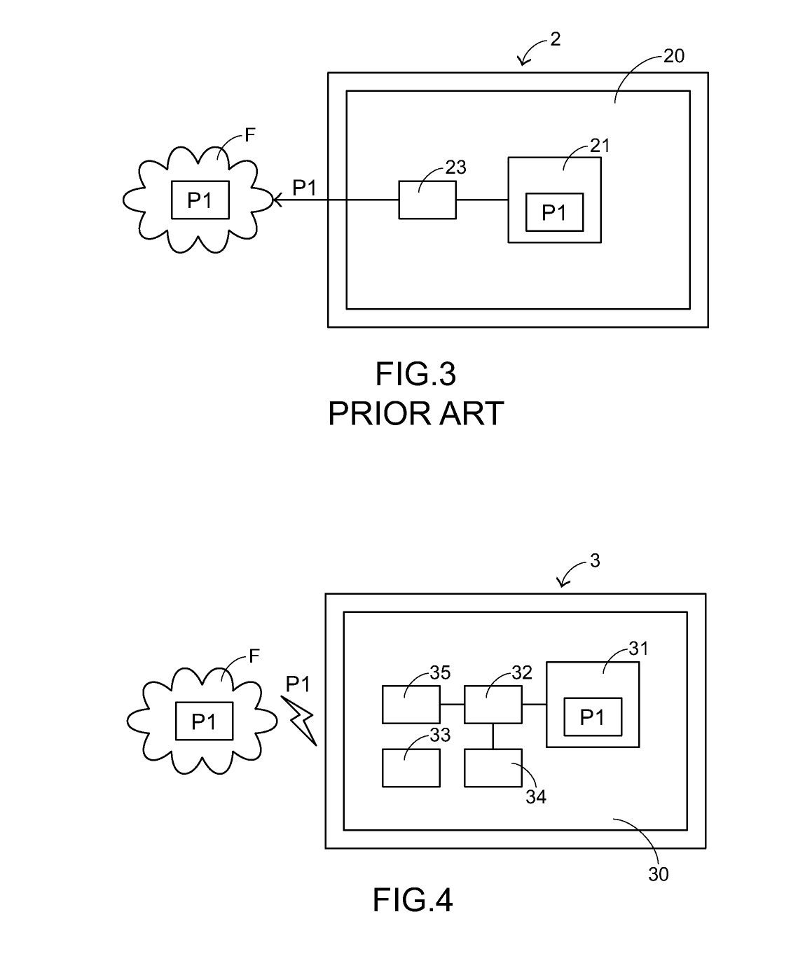

### DETAILED DESCRIPTION OF THE PREFERRED EMBODIMENT

For obviating the drawbacks encountered from the prior art, the present invention provides an electronic display device. FIG. 4 schematically illustrates an electronic display device in communication with a social website according to an embodiment of the present invention. As shown in FIG. 4, the electronic display device 3 comprises a display screen 30, a storage device 31, a transfer program 32, a wireless signal transmitter 33, a wireless signal receiver 34 and a network module 35. The display screen 30 is disposed on a surface of the electronic display device 3. The storage device 31 is disposed within the electronic display device 3 and in communication with the display screen 30. The storage device 31 is used for storing at least one image file P1. The image files comprise static electronic files (e.g. photos) and dynamic electronic files (e.g. movies). The display screen 30 is used for showing the stored image file P1. In this embodiment, the electronic display device 3 is a digital photo frame. The storage device 31 is a storage medium, which is disposed within the electronic display device 3. In some embodiments, the electronic display device 3 is an electronic signage, and the storage device 31 is a memory card or a removable storage device, which is externally connected with a connecting slot of the electronic display device 3. The transfer program 32 is installed in the electronic display device 3. The wireless signal transmitter 33 and the wireless signal receiver 34 are disposed within the electronic display device 3.

Please refer to FIG. 4 again. The network module 35 is disposed within the electronic display device 3 and connected with the storage device 31. The network module 35 is in communication with a social website F in a wireless network communication manner. An image file P1 is stored in the social website F. The image file P1 is copied and then transmitted to the storage device 31 of the electronic display device 3 through the network module 35. In an embodiment, the social website F is a Facebook social website, and the wireless network communication manner is a 3G wireless network communication manner, a 4G wireless network communication manner, a wireless fidelity (Wi-Fi) communication manner, a general packet radio service (GPRS) communication manner or an Edge network communication manner. After the image file P1 is transmitted from the social website F to the storage device 31, the image file P1 can be shown on the display screen 30 of the electronic display device 3. Under this circumstance, the observers inaccessible to the social website F can watch the image file P1. In some embodiments, the network module 35 is in communication with the social website F in an Internet connection manner.

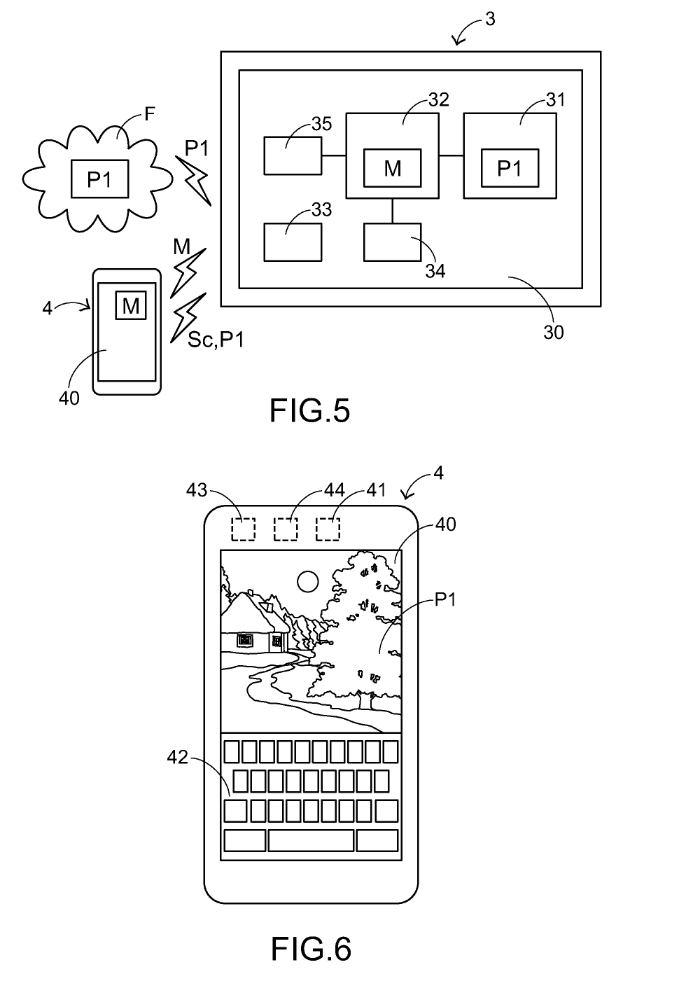

Please refer to FIGS. 5 and 6. FIG. 5 schematically illustrates the connection between the electronic display device of the present invention and a handheld electronic device. FIG. 6 schematically illustrates the handheld electronic device in communication with the electronic display device according to an embodiment of the present invention. The handheld electronic device 4 as shown in FIG. 5 is owned by an observer passing through the electronic display device 3. The wireless signal transmitter 33 of the electronic display device 3 is disposed within the electronic display device 3 for issuing a wireless connection signal Sc to the handheld electronic device 4 in the vicinity of the electronic display device 3. In such way, the connection between the electronic display device 3 and the handheld electronic device 4 is established. In this embodiment, the wireless signal transmitter 33 is a Bluetooth signal transmitter. In some embodiments, the wireless signal transmitter 33 is a near field communication (NFC) signal transmitter.

As shown in FIG. 6, the handheld electronic device 4 further comprises another display screen 40, another storage device 41, an input module 42, another wireless signal receiver 43 and another wireless signal transmitter 44. The storage device 41 is disposed within the handheld electronic device 4 for storing an image file. The display screen 40 is disposed on a surface of the handheld electronic device 4 for showing the image file that is stored in the storage device 41. The input module 42 is disposed on the surface of the handheld electronic device 4. Via the input module 42, the user may input characters or symbols as an evaluation message M (see FIG. 5). In this embodiment, the handheld electronic device 4 is a mobile phone, and the input module 42 is an on-screen keyboard shown on the display screen 40. In some embodiments, the input module 42 is a physical keyboard, which is arranged beside the display screen 40 and disposed on the surface of the handheld electronic device 4. The wireless signal receiver 43 is disposed within the handheld electronic device 4 for receiving the wireless connection signal Sc from the electronic display device 3. The wireless signal transmitter 44 is disposed within the handheld electronic device 4 for transmitting the evaluation message M to the wireless signal receiver 34 of the electronic display device 3. In this embodiment, the wireless signal transmitter 44 is a Bluetooth signal transmitter. Correspondingly, the wireless signal receiver 34 and the wireless signal receiver 43 are Bluetooth signal receivers. In some embodiments, the wireless signal transmitter 44 is a near field communication (NFC) signal transmitter. Correspondingly, the wireless signal receiver 34 and the wireless signal receiver 43 are near field communication (NFC) signal receivers.

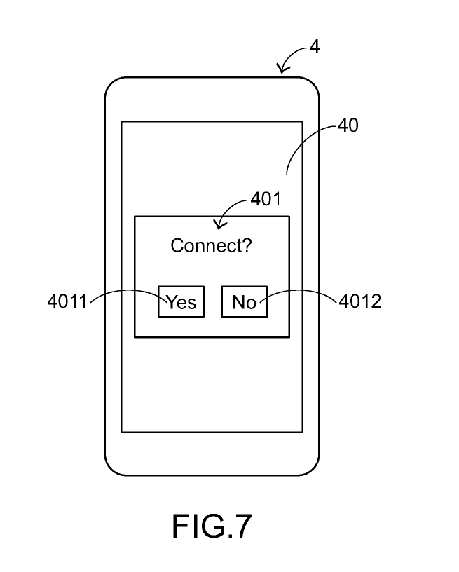

Hereinafter, the operations of the electronic display device 3 will be illustrated with reference to FIGS. 5 and 7. FIG. 7 schematically illustrates the contents of a connection confirming interface of the handheld electronic device in communication with the electronic display device according to an embodiment of the present invention. After the electronic display device 3 is completely set up, the network module 35 of the electronic display device 3 is in communication with the social website F in a wireless network communication manner. The image file P1 of the social web site F is copied and then transmitted to the storage device 31 of the electronic display device 3. Consequently, the image file P1 is shown on the display screen 30. Meanwhile, the wireless signal transmitter 33 of the electronic display device 3 issues a wireless connection signal Sc. The receiving status of the wireless connection signal Sc may be used to judge whether any electronic device is in the vicinity of the electronic display device 3. That is, if a user of the handheld electronic device 4 passes through the electronic display device 3, the wireless connection signal Sc is issued from the wireless signal transmitter 33 of the electronic display device 3 to the handheld electronic device 4 in the vicinity of the electronic display device 3. When the wireless connection signal Sc from the wireless signal transmitter 33 is received by the handheld electronic device 4, a connection confirming interface 401 is shown on the display screen 40. Via the connection confirming interface 401, the user may determine whether the connection between the electronic display device 3 and the handheld electronic device 4 will be established or not. As shown in FIG. 7, the connection confirming interface 401 includes a yes option 4011 and a no option 4012.

In a case that the yes option 4011 is clicked by the user of the handheld electronic device 4, it means that the user agrees to establish the connection between the electronic display device 3 and the handheld electronic device 4. After the connection between the electronic display device 3 and the handheld electronic device 4 is established, the image file P1 issued from the wireless signal transmitter 33 of the electronic display device 3 will be received by the wireless signal receiver 43 of the wireless signal transmitter 33 in a wireless transmission manner. Consequently, the image file P1 is shown on the display screen 40 (see FIG. 6). On the other hand, if the no option 4012 is clicked by the user of the handheld electronic device 4, it means that the user refuses to establish the connection between the electronic display device 3 and the handheld electronic device 4. Consequently, the connection confirming interface 401 is closed, and the connection between the electronic display device 3 and the handheld electronic device 4 is not established.

Please refer to FIG. 6 again. After the image file P1 is transmitted to the handheld electronic device 4 and stored in the storage device 41, the image file P1 and the input module 42 are shown on the display screen 40. Via the input module 42, the user of the handheld electronic device 4 may input characters or symbols as an evaluation message M. The evaluation message M will be transmitted from the wireless signal transmitter 44 of the handheld electronic device 4 to the wireless signal receiver 34 of the electronic display device 3 in a wireless transmission manner. Please refer to FIG. 5 again. After the evaluation message M is received by the electronic display device 3, the evaluation message M is transmitted from the transfer program 32 to the social website F through the network module 35. Moreover, the evaluation message M is posted on the social website F. Consequently, the evaluation message M associated with the image file P1 can be browsed by the users of the social website F.

From the above description, the electronic display device of the present invention provides an input mechanism for the public. First of all, the image file of the social website can be acquired by the electronic display device in a network communication manner. In addition, the connection between the electronic display device and the handheld electronic device near the electronic display device can be established in a wireless transmission manner. Consequently, the image file can be transmitted to the handheld electronic device to be watched by the user of the handheld electronic device. After the image file is watched, the user of the handheld electronic device may input an evaluation message through the input module of the handheld electronic device, and the evaluation message may be transmitted from the handheld electronic device to the electronic display device in the wireless transmission manner. Moreover, the evaluation message may be transmitted from the electronic display device to the social website in the network communication manner. Therefore, even if the electronic display device has no input module, the evaluation message associated with the image file can still be generated via the input module of the handheld electronic device. Moreover, even if the handheld electronic device is not network-enabled, the image file can still be shown on the display screen of the handheld electronic device and the evaluation message can be inputted by the handheld electronic device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic display device in communication with a social website, an image file being stored in said social website, said electronic display device comprising:
a display screen disposed on a surface of said electronic display device for showing said image file;
a wireless signal transmitter disposed within said electronic display device for issuing a wireless connection signal to a handheld electronic device in the vicinity of said electronic display device, thereby establishing connection between said electronic display device and said handheld electronic device, wherein said image file is transmitted from said wireless signal transmitter to said handheld electronic device in a wireless transmission manner;
a wireless signal receiver disposed within said electronic display device for receiving an evaluation message from said handheld electronic device; and
a transfer program installed in said electronic display device, and executed to transmit said evaluation message to said social website.

2. The electronic display device according to claim 1 further comprising a storage device for storing said image file from said social website, wherein said storage device is disposed within said electronic display device or externally connected with said electronic display device.

3. The electronic display device according to claim 2 wherein said storage device is a storage medium disposed within said electronic display device, or said storage device is a memory card or a removable storage device inserted in a connecting slot of said electronic display device.

4. The electronic display device according to claim 2 further comprising a network module, which is disposed within said electronic display device and connected with said storage device, wherein said network module is in communication with said social website through Internet connection or in a wireless network communication manner, so that said image file from said social website is copied and transmitted to said storage device.

5. The electronic display device according to claim 4 wherein said wireless network communication manner is a 3G wireless network communication manner, a 4G wireless network communication manner, a wireless fidelity (Wi-Fi) communication manner, a general packet radio service (GPRS) communication manner or an Edge network communication manner.

6. The electronic display device according to claim 1 wherein said wireless signal transmitter is a Bluetooth signal transmitter or a near field communication (NFC) signal transmitter, and said wireless signal receiver is a Bluetooth signal receiver or a near field communication (NFC) signal receiver.

7. The electronic display device according to claim 1 wherein said handheld electronic device comprises:
a second storage device disposed within said handheld electronic device for storing said image file from said electronic display device;
a second display screen disposed on a surface of said handheld electronic device for showing said image file from said electronic display device;
an input module disposed on said surface of said handheld electronic device for inputting characters or symbols as said evaluation message;
a second wireless signal receiver disposed within said handheld electronic device for receiving said wireless connection signal from said electronic display device; and
a second wireless signal transmitter disposed within said handheld electronic device for transmitting said evaluation message to said wireless signal receiver of said electronic display device.

8. The electronic display device according to claim 7 wherein said input module is a physical keyboard arranged beside said second display screen and disposed on said surface of said handheld electronic device, or said input module is an on-screen keyboard shown on said second display screen.

9. The electronic display device according to claim 7 wherein when said wireless connection signal from said wireless signal transmitter is received by said handheld electronic device, a connection confirming interface is shown on said second display screen, wherein via said connection confirming interface, said connection between said electronic display device and said handheld electronic device is determined to be established or not established.

10. The electronic display device according to claim 9 wherein said connection confirming interface comprises a yes option and a no option, wherein when said yes option is clicked, said connection between said electronic display device and said handheld electronic device is agreed to be established, wherein when said no option is clicked, said connection between said electronic display device and said handheld electronic device is refused to be established.
